(19) United States
(12) Patent Application Publication
(10) Pub. No.: US 2015/0274170 A1
(43) Pub. Date: Oct. 1, 2015

(54) INTEGRATED AUTOMATIC MANUAL MECHANICAL-TYPE STEPLESS TRANSMISSION DEVICE

(71) Applicant: Houjie Sun, Shenzhen city (CN)

(72) Inventor: Houjie Sun, Shenzhen city (CN)

(21) Appl. No.: 14/371,160

(22) PCT Filed: Dec. 25, 2012
(86) PCT No.: PCT/CN2012/001721

§ 371 Date: Jul. 8, 2014

(30) Foreign Application Priority Data
Jan. 18, 2012 (CN) 201210014010.1

(51) Int. Cl. B60W 30/18; B60W 10/18; B60W 10/101; F16H 59/02; F16H 61/02

(52) U.S. Cl. CPC B60W 30/18181; F16H 59/0204; F16H 61/0204; B60W 10/101; B60W 10/18

(57) ABSTRACT

Disclosed is an integrated manual automatic stepless gearbox mechanism based on a clutch-brake system with left foot operating brake pedal and right foot controlling accelerator pedal which is of an intrinsic safety model, free from pedaling by misplay or pedaling both simultaneously and puffs of black soot. A lotus gearlever assembled with lotus petal-type clutch switches is capable of being used in a fully manual mode and an automatic mode, in which the gearlever is coupled to a motor-drove gearbox by means of a flexible to rigid mechanical joint, and the traditional gearbox is upgraded to a stepless transmission device in virtue of 3-loop PID control strategy in the C program loaded in the Single Chip microcomputer named SCM to control. according to the driver's intention the device can shift gear, shift over gear or shift far gear automatically, Via a HMI the C program can set the various performances of the car such as smooth and comfortable mode or a sporty and powerful mode, thus making driving easy and as personal as ones wish. This invention further comprises two half-stroke mechanical clutch pulling bars, one half-stroke brake pulling bar, and one half-stroke sliding wire-wound rheostat type clutch pulling pole.

### FIELD OF THE INVENTION

The present invention relates to an integrated automatic manual gearbox device particular to a stepless gearbox device running in automatic mode or manual mode and its control program.

### BACKGROUND OF THE INVENTION

Today the vehicle equipped with the gearbox device can run in automatic mode or manual mode, and we have owns various stepless speed transformation device but do not with gearbox, and the clutch pedal and the brake pedal of all the vehicle is arranged on the left and right in the driver cab separately which is a hidden accident of traffic and already created uncountable traffic accidents, the phenomena will going on forever if no change for the state of the technology today.

The invention patent of “the vehicle brake device based on clutch-brake system” with the patent No. CN 201110094877.8 has been laid the brake pedal on the left, this invention further more designed two half-travel clutches and brake lever and created a stepless gearbox device which can be capable of running at either automatic or manual mode.

### SUMMARY OF THE PRESENT INVENTION

The intention of this invention is to provide a device of stepless gearbox integrated automatic mode and manual mode, additionally its significance lies in the using of this device can be able to insure people's lives and properties and accelerate the economic development.

The Software Brief Introduction:

This device controlled by its microcomputer program mainly including 3-PID loops and master control sub-program named master controller etc. which can run in ether automatic mode or manual mode,

The synchronizing velocity PID loop 1 can precisely synchronize the turning of the motor with the vehicle speed rapidly before the clutch fully meshing no matter of automatic mode or manual mode; the meshing and tracking PID loop 2 involves regulating right away after the achievement of the PID loop 1 regulating, its set value is the supplying fuel flow Ls corresponding with the accelerator pedal and its process variable PV is the actually supplying fuel flow so as to overcome factitious bumpy feeling; the smoothing fuel PID loop 3 is used for overcoming the fuel dithering due to bumpy road or factitiousness. the said above 3-loops PID program lead this device to stepless shifting gear performance, all of said PID control loops can run in anyone of manual mode or automatic mode.

according to the driving intention the device can shift gear automatically, has the functions of starting-up with higher gear, starting-up smoothly, driving at low speeds smoothly, isolating the clutch action at low speeds or when braking, the gearlever can be put in neutral location automatically after stopping, setting the various performances of the car via the human machine interface named HMI.

In order to carry out the said above functions in this invention designed the microcomputer programs, therein the automatic control program named auto comprised various function program paragraphs: the selection of shifting gear before startup named startup class selecting, shifting 4 or 5 gear after starts with 2 or 3 gear named the switching to 4 class after starts with 2 or 3 class, automatically shifting over, far, over down or far down gears named auto switches for exceeding class, automatically shifting gear according to the vehicle speed named auto switches class by class; therein the manual control program named semiauto comprised the program of presetting the shift ratio named presetting the ratio of semiauto shift gears; therein the several sub-program comprised: automatically shifting neutral gear after stopping for few minutes named stopped to 0 class( ), shifting gear named ZDHDn( ), frequency measuring named frequency( ), acceleration measuring named accelerate( ), supplying fuel acceleration and supplying fuel dithering measuring named acceleratefuel ( ), setting various parameters named HMI( ).

The Hardware Brief Introduction:

This device is comfortable and intrinsic safety due to the arrangement of the brake pedal on left and accelerator pedal on right, associating with the master controller subprogram in ether automatic or manual mode the vehicle can start with tree manner: the fully braking startup mode; the no braking startup mode; the un-fully braking startup mode, in any case starting from stillness can pedal the accelerator pedal and the brake pedal simultaneously to start powerfully.

In the condition of the clutch-brake pedal, this invention provide a electronic type half-travel clutch lever, two mechanical type half-travel clutch lever and a mechanical type half-travel brake lever.

The lotus gearlever which is flexible in the automatic mode and is rigid in the manual mode is used for shifting gear and mode; the layout of the sensor of gear position associated with the program make the device can preset the shift ratio for the gear position to be alternated to.

### BRIEF DESCRIPTION OF THE DRAWINGS

The invention is described in more detail below on the basis of the theories with reference to the accompanying drawings.

In the drawings,

FIG. 1 shows a sketch map of the mechanical type half-travel brake lever of vehicle.

FIG. 2 shows a cutaway view of one of the mechanical type half-travel clutch lever of vehicle.

FIG. 3 shows a cutaway view of another of the mechanical type half-travel clutch lever of vehicle.

FIG. 4 shows a side view of the electronic type half-travel clutch lever of vehicle.

FIG. 5 shows a front view of the electronic type half-travel clutch lever of vehicle.

FIG. 6 shows a sketch map of the layout of clutch cables of the clutch pedal and manual clutches.

FIG. 7 shows a sketch map of the installing of the idle electromagnetic valve.

FIG. 8 shows an assembling view of the lotus gearlever.

FIG. 9 shows a sketch map of the plane layout of the electro-drove device of the gearbox.

FIG. 10 shows a cutaway view of the automatic state of the flexible or rigid joint of the lotus gearlever.

FIG. 11 shows a cutaway view of the manual state of the flexible or rigid joint of the lotus gearlever.

FIG. 12 shows a ladder-type map of the microcomputer program of upgraded manual gearbox device based on the clutch-brake system.

FIG. 13-16 shows ladder-type maps of the master controller sub-program of the integrated automatic manual stepless gearbox.

### DESCRIPTION OF THE PREFERRED EMBODIMENTS

Herein give a detailed description for the present invention assisted with attached figures as follows.

Several Half-Travel Levers of the Clutch-Brake System Brake Device of Vehicle

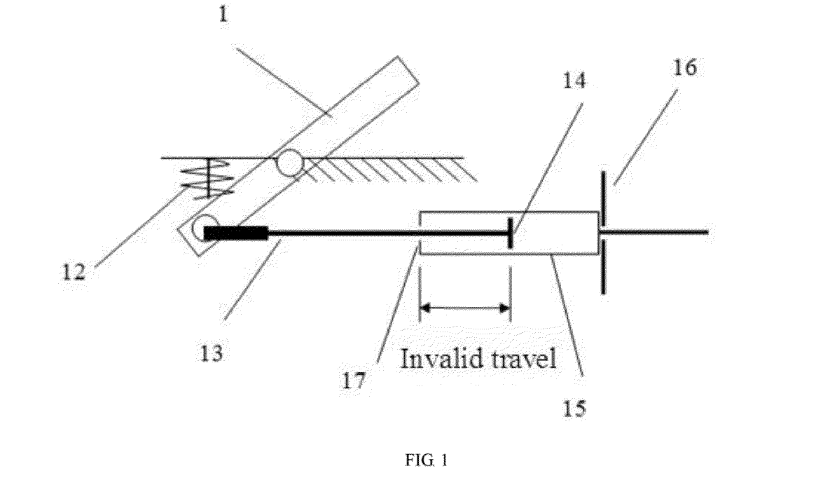

In FIG. 1, there is a half-travel brake lever for the clutch-brake pedal which integrated the clutch pedal and the brake pedal, in order to improve the performance of the vehicle which assembled or will assemble the clutch-brake pedal. The reset-spring 12 before the clutch-brake pedal 1 make the nail-type lever 13 back to the bottom of the cylinder-type lever 15 when the pedal is released, but the cylinder 15 is stopped by the circle (16) which is fixed on the body of the vehicle; when the pedal acting the nail head (14) is stopped by the end circle (17) of the said cylinder and then draw the cylinder along with the brake discs moving, so that can make free on its first-half braking travel of the brake lever.

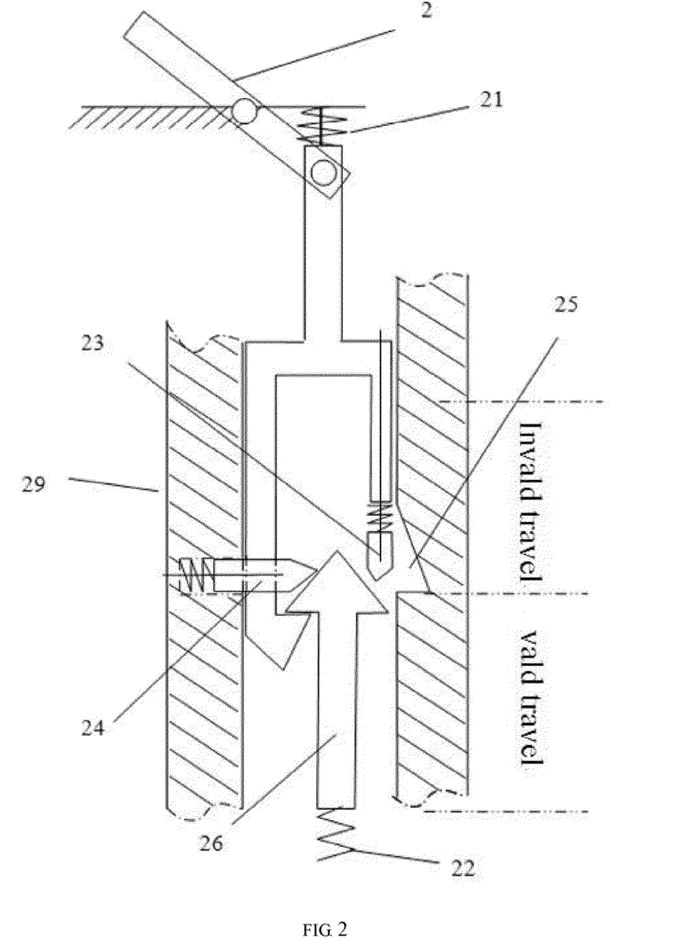

In FIGS. 1 and 2, there is a half-travel clutch lever for the clutch-brake pedal, its shell (29) is square canister or cylinder and is fixed on the body of vehicle, open a slot (25) on its inner wall, a fork pole which handle links to the pedal and supported by a reset spring (21) locates in upside of the inner shell, a pin (23) together with its reset spring and guide-pole are assembled on the top of a branch of said fork pole, when the fork pole moves downwards the said pin will force the arrow pole (26) head to be extruded out the said slot and be hung on the barb which is the top of another branch of the said fork pole, on an proper position of the inner wall opposite the said slot install a detaching pin (24) along with its reset spring and guide-pole which will compel the said arrow pole head into the said slot when the said fork pole moves upwards; a pull spring (22) links the underside of the arrow pole to the arm of the clutch, the pull of the said pull spring along with the thrust of the said detaching pin fix the arrow pole head in the said slot.

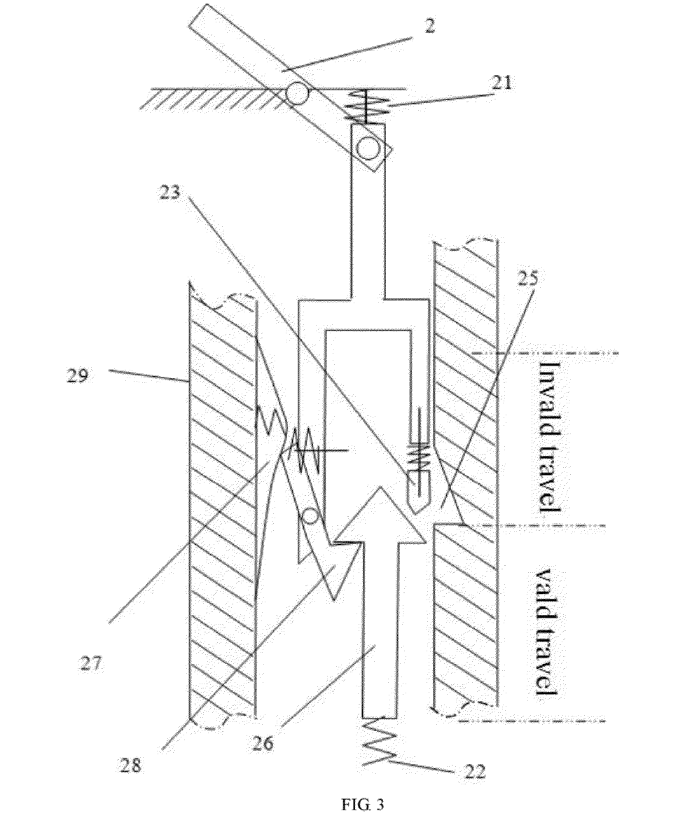

In FIG. 3, the difference between this structure with that of FIG. 2 lies in: the barb (28) which another end supports on the branch of the fork pole with its compressed spring and guide-pole joints to the branch top of the said fork pole with a shaft, on an proper position of the inner wall opposite the said slot install a spring film (27) supported by a compressed spring, when the said arrow pole (26) move up to a proper position the arrow pole head will be detached by the spring force of the spring film with the said barb and be compelled into the said slot; the head of the arrow pole hangs on the barb depending on the force of its compressed spring before entering into the slot and hangs on the slot depending on the pull of the pull spring and the friction after entering into the slot.

The said above pull spring (22) should be hung on the shell (29), additionally link the underside of the said arrow pole to the clutch arm (4) with a rigid pole to avoid enlarging the error of mechanical zero point of the clutch arm.

The said above half-travel clutch lever will occur a back-travel error when shifting between the first-half valid travel and the second-half invalid travel, it can be reduced but can not reach zero via precisely manufacture, so that should design the position of the back-travel error occurring outside the said valid travel to avoid the error occurring at the period of controlling the clutch.

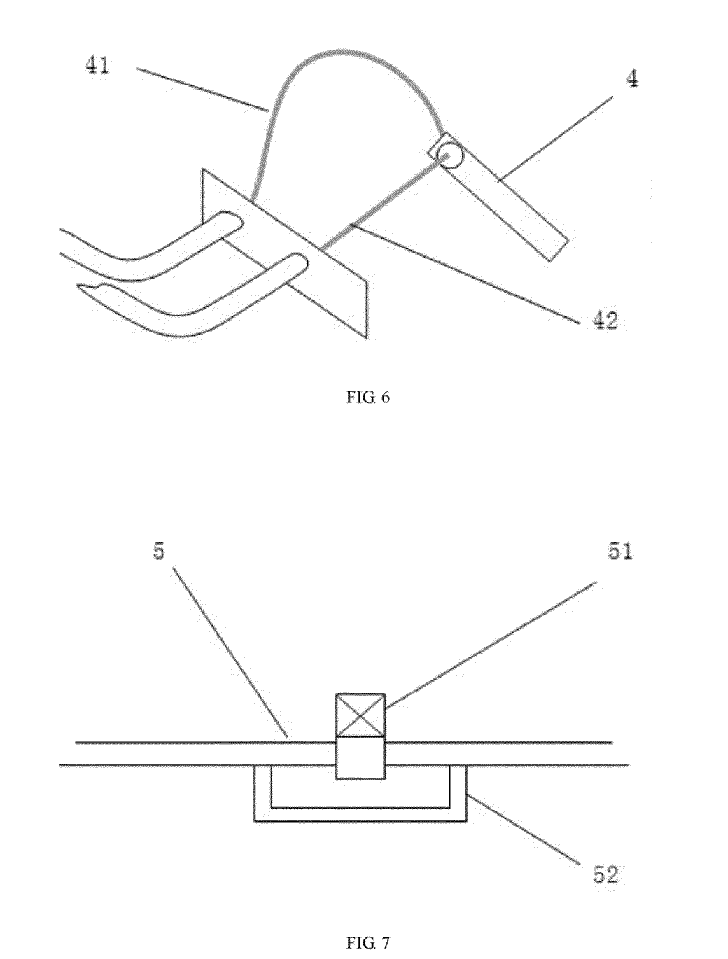

When the said half-travel clutch lever of the clutch-brake pedal cooperate with the said manual clutch switches, as is illustrated in the FIG. 6, the manual clutch switches control the clutch via a servo motor or a double speed motor through the brake cable (42), but the half-travel clutch lever operate the clutch through the brake cable (41) directly, and all them link to the clutch arm (4), herein their operation to the clutch are OR logic and the manual clutch switches own the priority of control which will realize the control for shifting gear while the clutch-brake pedal operates the clutch un-fully meshing, the operation of the manual clutch switches for shifting gear is easier than that of pedal.

The Upgraded Manual Shifting Gearbox and its Microcomputer Program Based on Clutch-Brake System:

This is a sample for this invention of the integrated automatic manual mechanical-type stepless transmission device.

The Hardware Structure of this Sample:

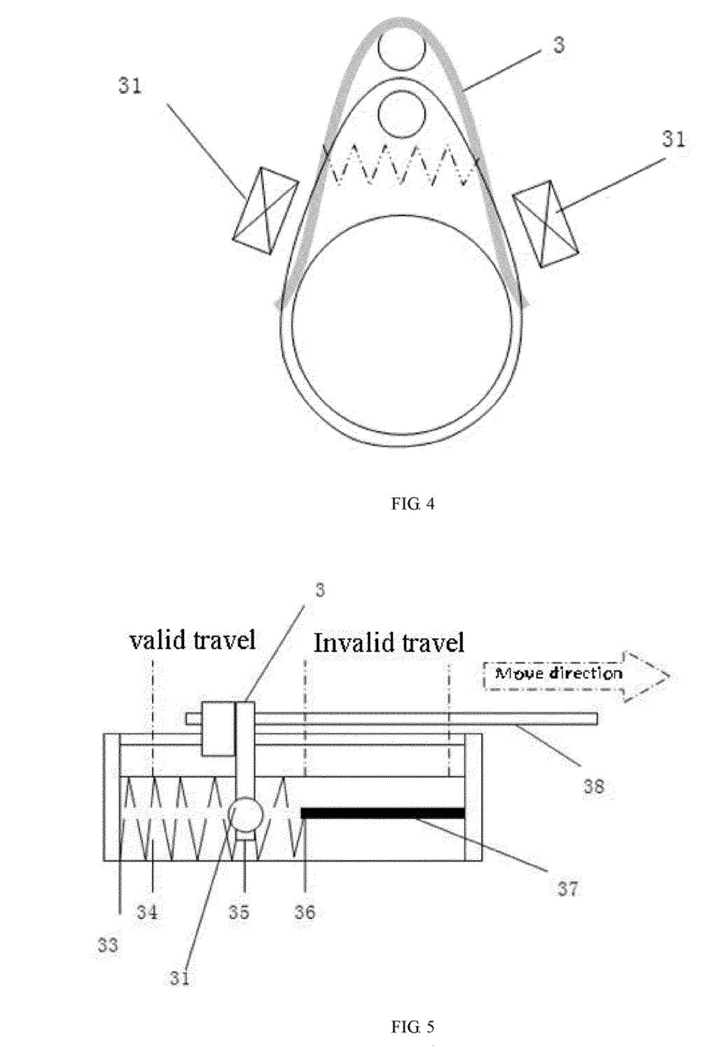

In FIG. 4-5, The sliding wire-wound rheostat with half-valid travel is the main parts of the electronic type clutch lever, its first-half is sliding resistance and its second-half is short-circuit slice, two electromagnets (31) are located above the sliding slices (3) so that the electromagnets can detach the sliding slices with the wirewound rheostat to reduce their abrasion when the vehicle speed exceeds its set value.

The said rheostat is fixed on the body of the vehicle, drawing with the clutch lever 38 the sliding slices will move from the start position (34), and the said rheostat will output the resistance R2 of the sliding slices fully meshing with the wirewound rheostat, 33 is the public wire, when moving will output the resistance value of RX through wire 35 which will control the clutch un-fully meshing, when the travel of the clutch-brake pedal exceeds a half will output the resistance value of R1 which will control the clutch fully detaching, the later travel on the short-circuit 37 is invalid and output the resistance value of R1.

The sliding wire-wound rheostat is used for the half-travel clutch-brake pedal, in case the clutch pedal and the brake pedal are laid on the left, the said sliding wire-wound rheostat is valid in the whole travel, its resistance signal is input into the Single Chip microcomputer named SCM and then will be transformed into standard engineering signal to control the clutch servo motor driving the clutch.

As is shown in the FIG. 8, A lotus gearlever (6, 61) is assembled with 3 or 4 lotus petal-type clutch switches which form a semiclosed shell coating on the top of gearlever, debugging the jiggling actions of the clutches to make them suitable to be operation by hand; in the C program the logic value of “OR” of signal of said manual clutch switches are used for shifting gear or alternating the modes between the automatic and the manual, the states of the signal can be keep till the clutch discs arrive its end location of detaching or meshing and can be locked each other, in the process of shifting and without the gear position signal the clutch can not mesh, but when the gearlever is in the neutral position the clutch can mesh to debug.

the manual clutch switches control the microcomputer program to output the movement control signal which based on the matched movement curve to control the clutch motor, and the clutch action periods are set according to the principle of pedaling fast and releasing slow, which will insure the smoothly shifting gear; the manual clutch switches own priority over the clutch pedal at any time;

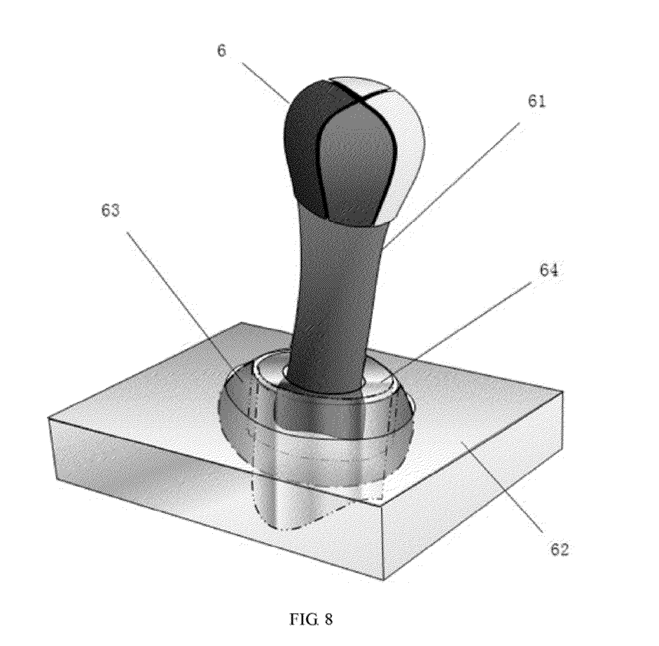

at the end travel position and start travel position of the brake pedal two travel switches are separately installed; the logic program will output a closed coil signal to control the idle electromagnetic valve showed in FIG. 7 idling the motor when braking at the moment of the vehicle velocity exceeding the set value, the sign of 5 is the supplying fuel tube, when the electromagnetic valve fully shut off there still remain a few of fuel flow to idle the motor, or fully shut off the fuel flow but the bypass tube (52) will idle the motor.

In the style of the clutch-brake system, to this device the clutch pedal and the brake pedal (or the half-travel clutch-brake pedal integrated the clutch pedal and the brake pedal) is operated by the left foot, the clutch is controlled by the sliding wirewound rheostat through the clutch motor, the accelerator pedal is controlled by the right foot. assisted with the lotus gearshift illustrated in the FIG. 8, when starting or in the low speed the clutch pedal or the clutch-brake pedal still control the vehicle to run un-fully meshing, or to shift gear, or to creep in low speed or to stop; when the vehicle speed exceeds the set value the program will isolate the action of the clutch, in the period of braking the function of isolation can reduce the abrasion of the clutch and efficiently utilize the haulage effect of the motor.

The Program Functions of this Sample:

This program wrote by Siemens 7-200 PLC SIMATIC ladder (can be translated into its instructions and the code of IEC 1131) should be translated into an enforceable computer language such as C code for SCM 51 while be put to trial.

In the case of using the high and low speeds of the servo motor with controller or double speeds motor to control the said device, with the Q0.3 below instead of the logic of Network 5, 6 to control the said motor in suitable speed meshing the clutch, and with the Q0.2 below to control the motor in high speed detaching the clutch, thus, the function of this device will be realized with only intermediate relays and logic chip but not the SCM.

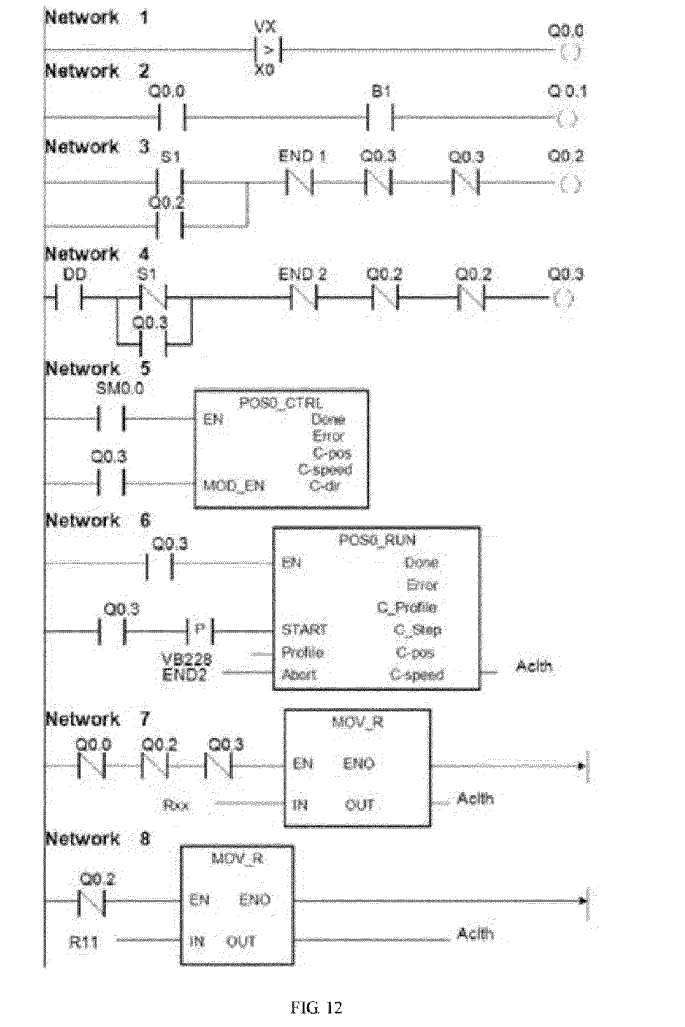

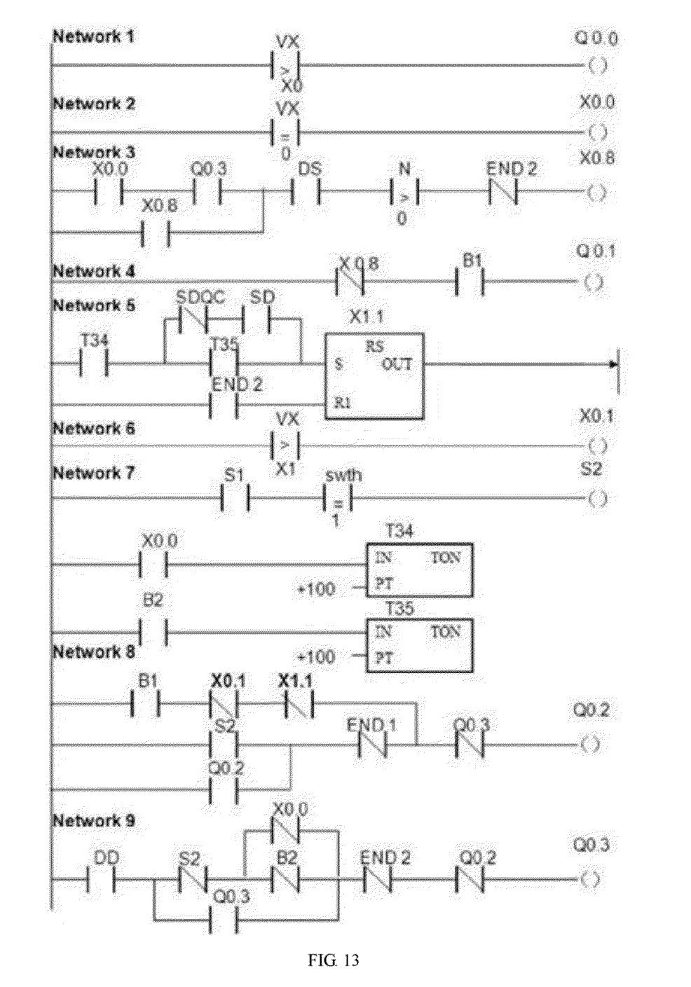

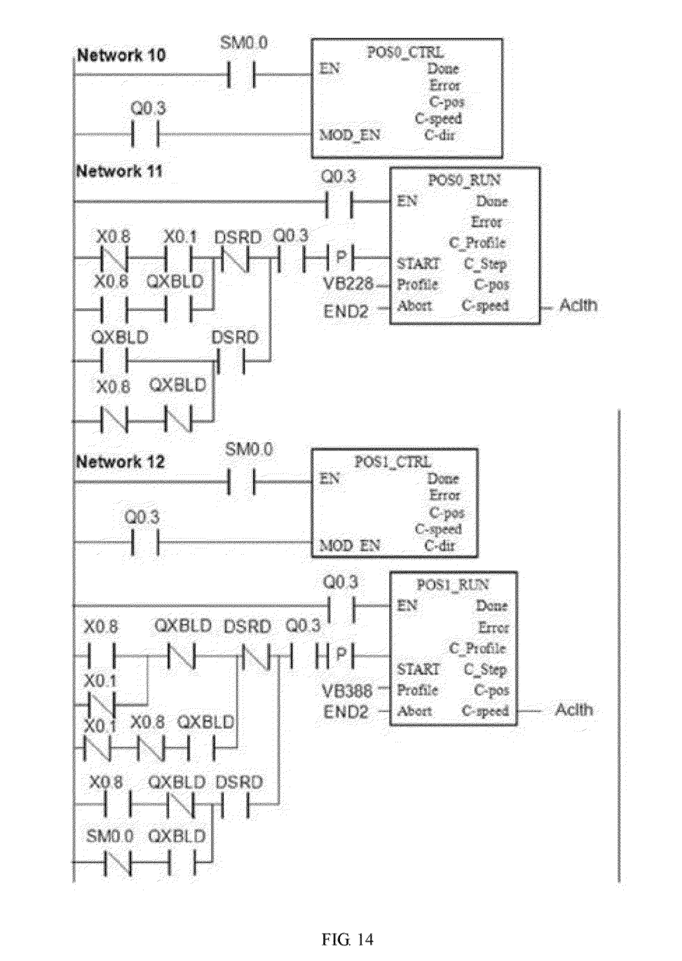

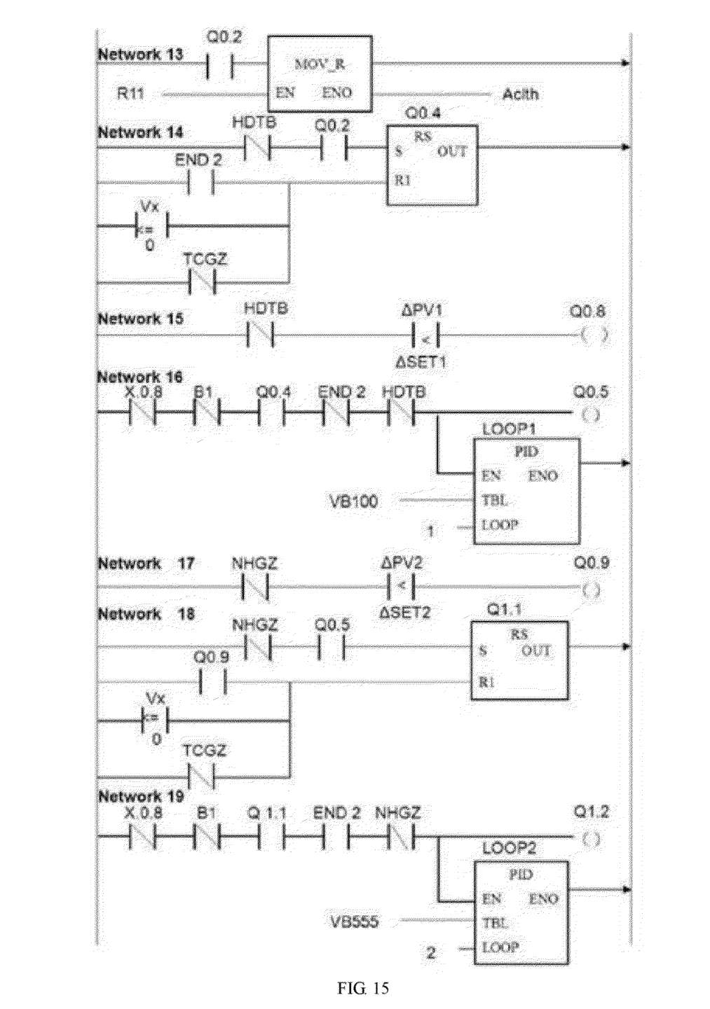

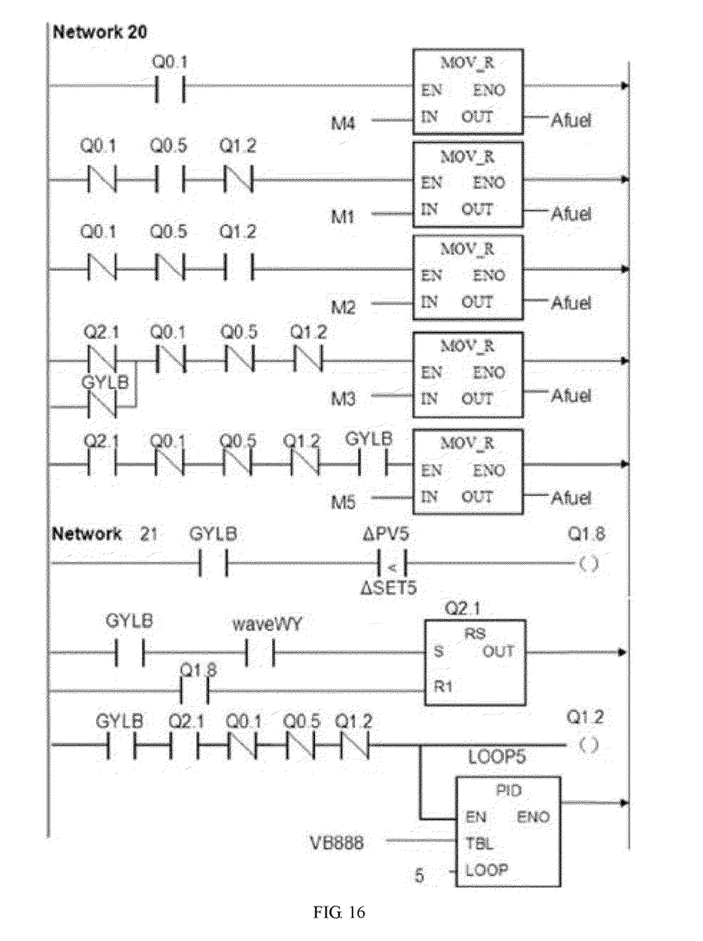

This logic program is shown in the FIG. 12 and noted below:

Network 1: //X: the threshold variable of speed, such as 8 km/h; V: real time speed. when the speed exceeds X output closed coil Q0.0.

Network 2: //B1: brake signal; Q0.1: to control the motor idling.

//when Q0.0, B1 closed at the same time output Q0.1 to idle the motor.

Network 3: //S1: the OR signal of the manual clutch; namely the instruction for detaching the clutch. //END1: the end position of the clutch detaching.

//when S1 acts and no END1, no Q0.3 then will output the instruction to detach the clutch Q0.2 and locked by itself till reach its end position.

Network 4: //DD: the OR signal of the gear position which can include the neutral position signal. //END2: the end signal of the clutch meshing.

//when S1 no acting and no END2 and Q0.2, and the gearlever is already in any gear position, then output the instruction of the clutch meshing Q0.3 and locked by itself till the end of meshing, this logic insure the clutch can not mesh when shifting and in the neutral position.

Network 5: //the inner always closed coil SM0.0 can insure the motion control module POS0_CTRL valid all the time, when Q0.3 is on, the program control the clutch servo motor meshing to its ends according to the presetting speed through the motion module POS0_RUN.

Network 6: //when the Q0.3 is on, POS0_RUN is enabled, startup by the up edge of pulse P and read the motion curve in VB288, this curve character lie in before the clutch discs touching each other the discs move with fastest speed but after touching with a suitable speed. At this paragraph the output is transformed into standard engineering signal to control the servo motor through the public register Aclth together with the two others signals below.

Network 7: //Rxx: the resistance of the clutch sliding wire-wound rheostat. //when the speed is slower than the presetting speed threshold value and there are no the instructions of meshing or detaching the clutch is controlled according to the resistance of the clutch-brake pedal so that can control the vehicle at low speed and starting or stopping. The manual clutch switches own the priority over the clutch pedal at any time.

Network 8: //R11: the resistance value of the said rheostat to fully detach the clutch, when there is manual clutch detaching instruction the clutch will be detached as soon as possible.

The Integrated Automatic Manual Stepless Gearbox Device and its Microcomputer Program:

This is a main sample for this invention of the integrated automatic manual mechanical-type stepless transmission device.

The Hardware Structure of this Main Sample:

Based on the style of the patent of clutch-brake system vehicle brake device (CN 201110094877.8), remove the clutch pedal, the left foot control the brake pedal of which at the start travel position and end travel position two travel switches B1, B2 are separately installed; the right foot operates the accelerator pedal which links a full-travel sliding wire-wound rheostat, the output resistance value of said rheostat is proportion to the travel of accelerator pedal and to the control signal M3 of throttle valve outputted by the SCM the lotus gearlever are the same function and structure as that said above sample. Additionally in this example, in the conditions of manual mode and no instruction of detaching the clutch at low speed by force the clutch will detach when the clutch switches switched on and will mesh when the clutch switches switched off, in the automatic mode can shift gear but can not operate the clutch.

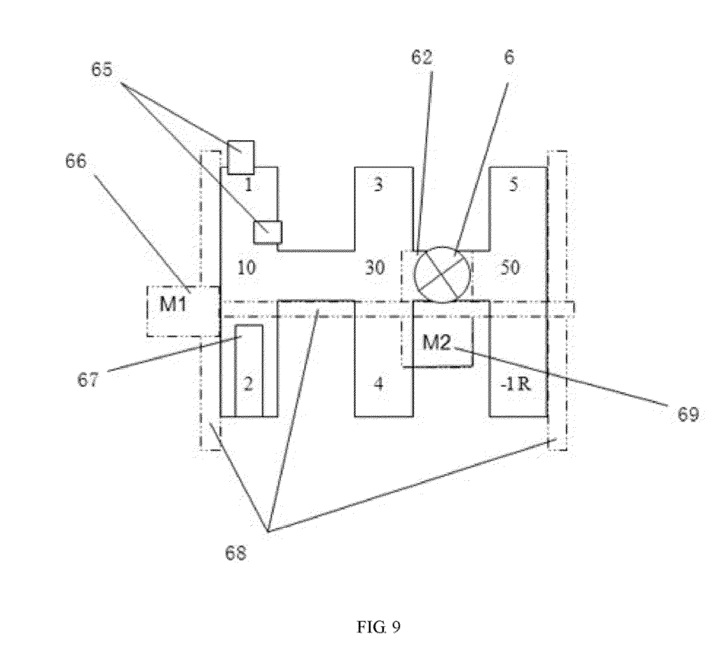

In the FIG. 8-9, the signs of 66, 69 indicate the stepper motor M1, M2 which are located at three guideways 68 to drive the bearing-support drive plank (62) so as to realize the xy plane movement, thus can locate the gear position of gearlever as well as the neutral, the gear potion and its number are exampled in the said figure, the program assign the value of the variable of CLSP according to the state of the gear position switches. Opposite the stepper motor M2 therein a set of ball-type rolling-bearing (63) is located on the same one movable bearing-support drive plank (62) together with the stepper motor M2, the said plank joint the ball-type rolling-bearing (63) by cardan mode so as to move the gearlever easily, as are illustrated in the FIG. 8,10, the lotus gearlever (61) insert into the mechanical gearlever (64) which get through the said ball-type rolling-bearing so as to decrease friction while shifting gear, the gearlever drives the motor in the manual mode but the motor drives the gearlever in the automatic mode.

Such as FIG. 9 is shown, installs a travel switch at each gearlever location including three neutral location, in the period of manual shifting gear in order to prolong the period of PID regulating from arriving the gear location to the clutch discs fully meshing, designs a longer dimension travel switch (67) which supported with a soft spring so that can shift gear easily and can deliver the gear location signal ahead of time; Or installs two gear location switches at one gear location (65); Or installs an electromagnetic or photoelectric approaching switch at the entrance of gear position where the gearlever has been decided to enter and has no possible to withdraw.

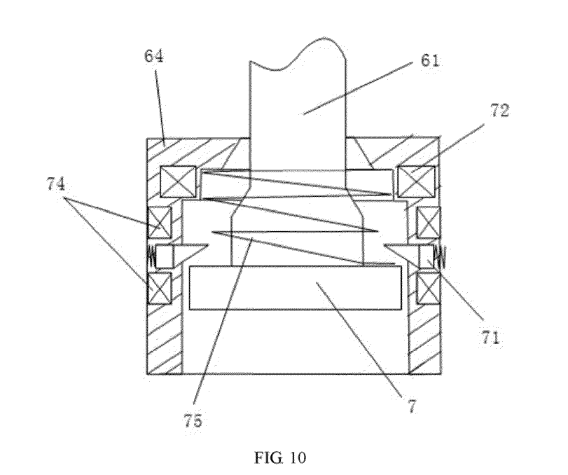

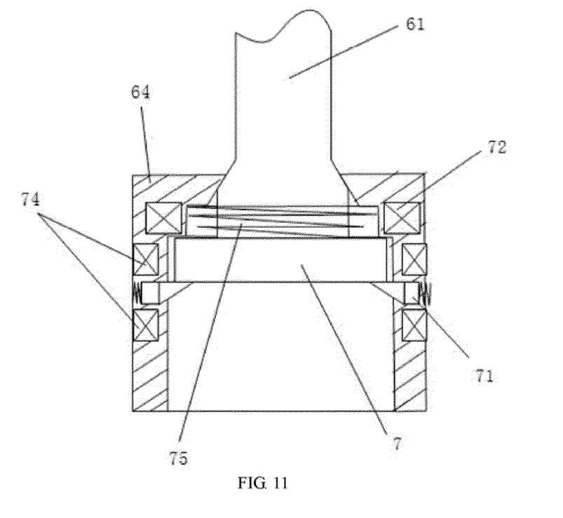

As is shown in the FIG. 10-11, the lotus gearlever (61) is jointed to the mechanical gearlever (64), when the electromagnetic coil (72) of the mechanical gearlever switch on the joint which links the lotus gearlever to the mechanical gearlever is on the rigid state of manual mode so as to shift gear, when the electromagnetic coil (74) of the mechanical gearlever switch on and the electromagnetic coil (72) switch off the iron fastener (71) draw back so the gearlever back to the flexible state of automatic mode, at this time, the joint said above is supported by a hard spring (75) and the gearlever can be hardly move by hand to shift gear; the program loaded in the SCM according to the signal of the automatic mode or the manual mode to switch the electromagnetic coils said above on several seconds to control the state of gearlever.

This device adds the electro-drove equipment onto the traditional gearbox, the clutch is controlled by the servo motor, the actions of shifting gear controlled by the micro-computer, thus the traditional gearbox is upgraded to a automatic stepless shifting type and can run in a pure manual mode simultaneously.

The motor-drove equipment for automatically shifting gear said above can be replaced by a Hydraulic-drove or a gas-drove equipment controlled by the SCM which should be consult the resource of its vehicle.

This invention device is a intrinsic safe type, based on the clutch-brake system brake device of vehicle, do pedal without mistakes, do not worry about pedaling simultaneously, can avoid the accidents due to pedal the brake pedal or accelerator pedal by mistake particularly to correct it with no time, but this device has enough time to correct the mistakes for controlling the pedals separately by double feet.

The Program Functions of this Main Sample: for automatic mode, can set 1 gear or 1, 2, 3 gear or any gear to start and can shift to corresponding gear by hand, the gearlever will be shifted to the 1 gear by force when it is shifted into the un-set gear, after starting with 2 or 3 gear several seconds the gearlever will be shifted into 3 or 4 gear by force maintaining several seconds till reaching the set speed at its gear or releasing force as exceeding the set time; in the condition of starting with not 1 gear, after starting within several seconds the action of automatically shifting gear is forbidden;

In the automatic mode with normal vehicle speed the device will shift gear according to the set speeds and the vehicle speed confirmed within several seconds; when the acceleration reaches its set value 1 but the speed does not reach its set value in the condition of suddenly braking or going on slope the device will shift over gear, that is to say, shift one gear for one times; when the acceleration increases continually and exceeds its set value 2 the device will shift far gear, that is to say, shift two gears for one times; the device will shift over down gear of one when the deceleration of speed or supplying fuel reaches its set value −1 but the speed does not reach its set value, when the deceleration decreases continually and exceeds its set value −2 the device will shift far down gear, that is to say, shift down two gears for one times; after shift over, far, over down or far down gears it will enter the stable period of locking the gear for several seconds till reaching the set speed at its gear or releasing force as exceeding the set time, subsequently will enter the mode of shifting gear according to the normal speed.

the said device enters the manual mode after its SCM is switched on and can enter the automatic mode when the gearlever do not be located on the R gear position and the speed is equal to or greater than 0 if only the manual clutch switches said above are turned on twice or more within one second, the operation said above can be replaced by a trigger switches on a appropriate position in the cab or on the HMI touch screen; in the automatic mode shifting reverse gear or reversing vehicle unintentionally the automatic mode will be forced to the manual mode; when the vehicle running in the automatic mode it is invalid to shift forward gear by hand; in any mode when checking out not shifting neutral gear after stopping for few minutes or after the SCM rebooting for few minutes the device will shift neutral gear automatically and maintain the previous mode;

In any mode when being stillness can shift gear or shift neutral gear if only the SCM receives the signal of brake in spite of the signal of throughout brake; The fully braking startup mode: when the manual clutch switches are free with throughout braking the vehicle can start smoothly after releasing the brake pedal slightly, namely the vehicle can start after all of the signals of manual clutch switches and throughout braking disappear; The no braking startup mode: when the manual clutch switches are all in the state of free and the braking signal already emerges but not the throughout braking the vehicle can start smoothly after the braking signal disappear; The un-fully braking startup mode: when not fully braking the vehicle will start smoothly if only releasing the manual clutch switches after switching on; in any case starting from stillness can pedal the accelerator pedal and the brake pedal simultaneously so as to obtain the aims of quickly starting and promoting the performance of power; it can be selected between the smoothly starting namely starting with un-fully meshing and the quickly starting namely starting with fully meshing;

When the vehicle runs at the velocity less than that of set value of low the clutch will be detached by force after braking in spite of throughout or not, at this time can shift gear or shift neutral gear or park directly, when the braking signal disappear but the vehicle still run the vehicle will enter the state of un-fully meshing accelerating namely low speed creeping just as starting; the motor will be forced to be idle when braking out of the period of startup, which can be controlled via the idle electromagnetic valve (51) on the supplying fuel tube (5) or the fuel throttle valve; the best performances of smoothly starting or strong power can be achieved via the clutch meshing curves and time loaded in the SCM and executed in the period of shifting gear or starting;

The 3-Loops PID Regulation:

the said device controlled by the said SCM in which is loaded the mainly including 3-loops PID program can regulate shifting gear smoothly and rapidly which lead to its stepless shifting gear performance, additionally can smooth the supplying fuel when encountering bumpy road, all of said PID control loops can run in anyone of manual mode or automatic mode;

The Synchronizing Velocity PID Loop 1:

In the manual mode, basing on the curve or function of the idling rotation rate of motor with the supplying fuel, according to current gear position, vehicle acceleration and state of supplying fuel, the said PID loop program can preset the shift ratio of the target gear position in real time, and calculate the equivalent vehicle speed of motor Vy=K*N/DX, Wherein the said N is the motor rotation rate, the said DX is the shift ratio of being preset for the gear position to be alternated to and then replaced by the actual shift ratio if the action of shifting gear takes place actually, The said K is the proportion coefficient for the output shaft of gearbox transformed to the vehicle velocity; The said Vy is programmed as a regulated variable to track the velocity of vehicle namely set value in real time and its output will regulate the throttle valve, After reaching its intended gear position of gearlever the transformed velocity based on the actual gear location will be treated as controlled variable in the process of PID regulating namely process variable at once, when the gear position actually reached does not correspond with the intended position the program will add the differential regulating function to shorten the regulating period, so that can precisely synchronize the turning ratio of the motor with the vehicle speed rapidly before the clutch fully meshing to achieve the performance of shifting with no disturbance; The said PID loop do not regulate when the vehicle is in the state of neutral gear or stopping in the period of running:

Under the automatic mode, in the program of PID regulation, the value of the shift ratio register DX which in the function of controlled variable Vy is assigned by the target gear register ZD, in the process of the detaching clutch, shifting gear and meshing clutch sequentially the PID loop regulating has enough time to synchronize Vy with vehicle velocity; in the period of automatically shifting gear the clutch can not mesh and can remain to regulate when passing the position of neutral;

The Meshing and Tracking PID Loop 2:

the said PID loop 2 involves regulating right away after the achievement of the PID loop 1 regulating, its output value M3 is used for regulating the throttle valve to track the accelerator pedal, and its set value is the supplying fuel flow Ls corresponding with the travel resistance R of the accelerator pedal, base on the function or curve of Ls-R which should be obtained by experiment to provide the set value of the variable of supplying fuel flow Ls for the said PID loop 2; the process variable PV is the actually supplying fuel flow obtained by measuring;

In the process of regulating under the automatic or the manual mode the PID loop 2 is used to correct the difference between the pedal supplying fuel flow and the output fuel flow of the PID loop 1 at the shifting moment while the PID loop 1 control is being switched to the accelerator pedal control, thus overcome artificial bumpy feeling, that is to say, after shifting gear not switch the supplying fuel to that of pedal operating but to that of PID loop 2 controlling and equal the actual supplying fuel flow to the corresponding fuel flow of the pedal controlling as soon as possible, when the supplying fuel flows error of the pedal controlling with the actual supplying up to its set limit the program will deliver the control of throttle to the pedal;

The Smoothing Fuel PID Loop 3:

this control loop is used for overcoming the fuel dithering due to bumpy road or factitiousness;

The set value in the said PID loop is the supplying fuel flow Ls corresponding with the accelerator pedal travel resistance R, the process variable PV is the actual supplying fuel flow Lp. When check out the strongly dithering of the supplying fuel flow by the subprogram named acceleratefuel( ), waveWY=1 and this PID loop starts to regulate the fuel supplying till the error of Δ PV5 is less than the set value of Δ SET5 then quits, its output M5 is used to regulate the throttle valve, which priority is higher than that of accelerator pedal but lower than that of the PID loop 1 and the PID loop 2, the output of brake to idle motor owns the highest priority over all others;

Or can connect a smoothing fuel bottle to the supplying fuel tube after supplying fuel pump before the throttle valve instead of the function of the said PID loop 3.

The Human Machine Interface HMI:

This device is enabled to be maintained namely which partial parameters can be set manually via the subprogram HMI. With installing a touch screen or which shares with a navigator in the driver's cab, then input password to set the following parameters at any time: Password modification, the selection of startup with meshing fully or un-fully, the low speed value setup for detaching the clutch by force, enabling the function of creeping at low speed, the selection of gears before startup, enabling to force the gear to 4 or 5 gear position after startup, setting the value of time locked in 4 or 5 gear position after startup, setting the shifting gear speed and its delay time to confirm the said speed, enabling the function of synchronizing velocity PID, enabling the function of meshing and tracking PID, enabling the function of smoothing fuel PID, enabling the function of automatically shifting over gear, enabling the function of automatically shifting far gear, enabling the function of automatically shifting over down gear, enabling the function of automatically shifting far down gear, setting the acceleration value of speed or supplying fuel for shifting over, far, over down or far down gears, setting the locking gear time after shifting over, far, over down, far down gears, setting the period of delay to shift neutral gear after stopping, enabling the function of starting with clutch switches manually, recovering the manufacturer setup; the set functions is enabled after achievement of setting and can run at once, the SCM will load and enable the last strategy setup after reboot.

In order to carry out the said above functions in this invention designed the microcomputer program, therein the automatic control program named auto program which comprises various functions as follow: the selection of shifting gear before startup named startup class selecting, shifting 4 or 5 gear after startup with 2 or 3 gear named the switching to 4 class after starts with 2 or 3 class, automatically shifting over, far, over down or far down gears named auto switches for exceeding class, automatically shifting gear according to the vehicle speed named auto switches class by class; therein the manual control program named semiauto program which comprises various functions of the device as follow: presetting the shift ratio named presetting the ratio of semiauto shift gears; therein several sub-programs which comprises various functions as follow: master control named master controller ( ) comprises functions of the fundamental control to the clutch, brake discs and throttle, of the control to startup mode, of the advance regulation for stepless shifting for gearbox, automatically shifting neutral gear after stop for few minutes named stopped to 0 class( ), shifting gear named ZDHDn( ), frequency measuring named frequency( ), acceleration measuring named accelerate( ), supplying fuel acceleration and supplying fuel dithering measuring named acceleratefuel ( ), setting various parameters named HMI( ).

The Program of this Main Sample:

The Economic and Social Benefit:

The intention of this invention is to provide a device of stepless gearbox integrated automatic mode and manual mode, additionally its significance lies in the using of this device can be able to insure people's lives and properties and accelerate the economic development.

Said above, others promised by law may draw out modifications and variations according to the structures and techniques and principles of this invention, therefore that the appended claims are intended to cover such modifications and variations which are within the true scope and spirit of this invention.

1. an integrated automatic manual stepless gearbox device, its characters lies in, a brake pedal is arranged on the left while an accelerator pedal is arranged on the right and without clutch pedal in the driver's cab, integrated automatic and manual function, the automatically drove traditional gearbox obtained the function of stepless speed change via being regulated by the 3 loops PID control program which loaded in the microcomputer, according to the driving intention the device can shift gear automatically, has the functions of starting-up with higher gear, starting-up smoothly, driving at low speeds smoothly, isolating the clutch action at low speeds or when braking, the gearlever can be put in neutral location automatically after stopping, setting the various performances of the car via the human machine interface named HMI;
A lotus gearlever (6,61) is assembled with 3 or 4 lotus petal-type clutch switches which form a semiclosed shell coating on the top of gearlever, in the C program the logic value of OR of signal of said manual clutch switches are used for shifting gear or alternating the modes between the automatic and the manual, the states of the signal can be keep till the clutch discs arrive its end location of detaching or meshing and can be locked each other, in the conditions of manual mode and no instruction of detaching the clutch at low speed by force the clutch will detach when the clutch switches switched on and will mesh when the clutch switches switched off, associates with the lotus gearlever to accomplish the action of shifting gear, the clutch cannot mesh in the travel of shifting gear, in the automatic mode can shift gear but can not operate the clutch;
The lotus gearlever (61) links with the mechanical gearlever (64) through the mechanical joint, the two levers said above integrate into a gearlever, in the automatic mode the gearlever is flexible and in the manual mode the lever is rigid;
Based on the concept of the brake-clutch system vehicle brake device, the brake pedal said above can replace with a clutch pedal and a brake pedal which controlled by the left foot, or replace with a pedal operated by left foot which integrate the normal brake pedal and the normal clutch pedal named clutch-brake pedal, in such cases, in the conditions of low speeds or starting the clutch-brake pedal or the clutch pedal control vehicle to run or detach the clutch to stop by the mean of un-fully meshing of the clutch, in the condition of braking when the vehicle speed exceeding the set value the device can shields the clutch actions and leads the engine to be idle.

2. According to claim 1 said an integrated automatic manual stepless gearbox device, wherein its characters lies in, remove the traditional clutch pedal, the brake pedal is operated by the left foot, at the end travel position and start travel position of the brake pedal two travel switches are separately installed; the right foot operates the accelerator pedal which links a full-travel sliding wire-wound rheostat, the output resistance value of said rheostat is proportion to the travel of accelerator pedal and to the control signal of throttle valve outputted by the SCM; install a set of motor-drove automatically shifting gear device on the gearbox which can be replaced by a Hydraulic-drove or a gas-drove device controlled by the SCM;
installs a travel switch at each gearlever location including three neutral location, in the period of manual shifting gear in order to prolong the period of PID regulating from arriving the gear location to the clutch discs fully meshing, designs a longer dimension travel switch (67) which supported with a soft spring so that can shift gear easily and can deliver the gear location signal ahead of time; Or installs two gear location switches at one gear location (65); Or installs an electromagnetic or photoelectric approaching switch at the entrance of gear position where the gearlever has been decided to enter and has no possible to withdraw.
The stepper motors M1 and M2 which locate on the three guideways separately drive the bearing-support drive plank (62) to realize the planar motion, the SCM program locate the potions of every gear of gearlever including the neutral, opposite the stepper motor M2 wherein a set of ball-type rolling-bearing is located on the same one movable bearing-support drive plank (62) together with the stepper motor M2, the said plank joint the ball-type bearing (63) via cardan mode so as to move the gearlever easily, and the lotus gearlever insert into the mechanical gearlever (64) which get through the said ball-type rolling-bearing so as to decrease friction while shifting gear, the gearlever drives the motor in the manual mode but the motor drives the gearlever in the automatic mode;
The lotus gearlever (61) is jointed to the mechanical gearlever (64), when the electromagnetic coil (72) of the mechanical gearlever switch on the joint which links the lotus gearlever to the mechanical gearlever is on the rigid state of manual mode so as to shift gear, when the electromagnetic coil (74) of the mechanical gearlever switch on and the electromagnetic coil (72) switch off the iron fastener (71) draw back so the gearlever back to the flexible state of automatic mode, at this time, the joint said above is supported by a hard spring (75) and the gearlever can be hardly move by hand to shift gear; the program loaded in the SCM according to the signal of the automatic mode or the manual mode to switch the electromagnetic coils said above on several seconds to control the state of gearlever.

3. According to claim 1 said an integrated automatic manual stepless gearbox device, wherein its characters lies in, for automatic mode, can set 1 gear or 1, 2, 3 gear or any gear to start and can shift to corresponding gear by hand, the gearlever will be shifted to the 1 gear by force when it is shifted into the un-set gear, after starting with 2 or 3 gear several seconds the gearlever will be shifted into 3 or 4 gear by force maintaining several seconds till reaching the set speed at its gear or releasing force as exceeding the set time; in the condition of starting with not 1 gear, after starting within several seconds the action of automatically shifting gear is forbidden;
In the automatic mode with normal vehicle speed the device will shift gear according to the set speeds and the vehicle speed which will be confirmed within several seconds; when the acceleration reaches its set value 1 but the speed does not reach its set value in the situation of suddenly braking or going on slope the device will shift over gear, that is to say, shift one gear for one times; when the acceleration increases continually and exceeds its set value 2 the device will shift far gear, that is to say, shift two gears for one times; the device will shift over down gear of one when the deceleration of speed or supplying fuel reaches its set value −1 but the speed does not reach its set value, when the said decelerations decreases continually and exceeds its set value −2 the device will shift far down gear, that is to say, shift down two gears for one times; after shift over, far, over down or far down gears it will enter the stable period of locking the gear for several seconds till reaching the set speed at its gear or releasing force as exceeding the set time, subsequently will enter the mode of shifting gear according to the normal speed.

4. According to claim 1 said an integrated automatic manual stepless gearbox device, wherein its characters lies in, the said device enters the manual mode after its SCM is switched on and can enter the automatic mode when the gearlever do not be located on the R gear position and the speed is equal to or greater than 0 if only the manual clutch switches said above are turned on twice or more within one second, the operation said above can be replaced by a trigger switches on a appropriate position in the cab or on the HMI touch screen; in the automatic mode shifting reverse gear or reversing vehicle unintentionally the automatic mode will be forced to the manual mode; when the vehicle running in the automatic mode it is invalid to shift forward gear by hand; in any mode when checking out not shifting neutral gear after stopping for few minutes or after the SCM rebooting for few minutes the device will shift neutral gear automatically and maintain the previous mode;
In any mode when being stillness can shift gear or shift neutral gear if only the SCM receives the signal of brake in spite of the signal of throughout brake; The fully braking startup mode: when the manual clutch switches are all free with throughout braking the vehicle can start smoothly after releasing the brake pedal slightly, namely the vehicle can start after all of the signals of manual clutch switches and throughout braking disappear; The no braking startup mode: when the manual clutch switches are all in the state of free and the braking signal already emerges but not the throughout braking the vehicle can start smoothly after the braking signal disappear; The un-fully braking startup mode: when not fully braking the vehicle will start smoothly if only releasing the manual clutch switches after switching on; in any case starting from stillness can pedal the accelerator pedal and the brake pedal simultaneously so as to obtain the aims of quickly starting and promoting the performance of power; it can be selected between the smoothly starting namely starting with un-fully meshing and the quickly starting namely starting with fully meshing; When the vehicle runs at the velocity less than that of set value of low the clutch will be detached by force after braking in spite of throughout or not, at this time can shift gear or shift neutral gear or park directly, when the braking signal disappear but the vehicle still run the vehicle will enter the state of un-fully meshing accelerating namely low speed creeping just as starting; the motor will be forced to be idle when braking out of the period of startup, which can be controlled via the idle electromagnetic valve (51) on the supplying fuel tube (5) or the fuel throttle valve; the best performances of smoothly starting or strong power can be achieved via the clutch meshing curves and time loaded in the SCM and executed in the period of shifting gear or starting;
When the idle valve (51) shut off there still exists a few of fuel flow to maintain motor being idle, or the idle valve entirely shut off but its bypass tube makes the motor idling.

5. According to claim 1 said an integrated automatic manual stepless gearbox device, wherein its characters lies in, the said device controlled by the said SCM in which is loaded the mainly including 3-loops PID program can regulate shifting gear smoothly and rapidly which lead to its stepless shifting gear performance, additionally can smooth the supplying fuel when encountering bumpy road, all of said PID control loops can run in anyone of manual mode or automatic mode;
The synchronizing velocity PID loop 1: in the manual mode, basing on the curve or function of the idling rotation rate of motor with the supplying fuel, according to current gear position, vehicle acceleration and state of supplying fuel, the said PID loop program will preset the shift ratio of the target gear position in real time, and calculate the equivalent vehicle speed of motor Vy=K*N/DX, Wherein the said N is the motor rotation rate, the said DX is the shift ratio being preset for the gear position which will be alternated to and then to be replaced by the actual shift ratio if the action of shifting gear takes place actually, The said K is the proportion coefficient for the output shaft of gearbox transformed to the vehicle velocity; The said Vy is programmed as a regulated variable to track the velocity of vehicle which is treated as set value in real time and its output is to regulate the throttle valve, After reaching its intended gear position of gearlever the transformed velocity based on the actual gear location will be treated as controlled variable in the process of PID regulating namely process variable at once, when the gear position actually reached does not correspond with the intended position the program will add the differential regulating function to shorten the regulating period, so that can precisely synchronize the turning ratio of the motor with the vehicle speed rapidly before the clutch fully meshing to achieve the performance of shifting with no disturbance; The said PID loop do not regulate when the vehicle is in the state of neutral gear or stopping in the period of running;
Under the automatic mode, in the program of PID regulation, the value of the shift ratio register DX which in the function of controlled variable Vy is assigned by the target gear register ZD, in the process of the detaching clutch, shifting gear and sequentially meshing clutch the PID loop regulating has enough time to synchronize Vy with vehicle velocity; in the period of automatically shifting gear the clutch can not mesh and can remain to regulate when passing the position of neutral;
The meshing and tracking PID loop 2: the said PID loop 2 involves regulating right away after the achievement of the PID loop 1 regulating, its output value is used for regulating the throttle valve to track the accelerator pedal, and its set value is the supplying fuel flow Ls corresponding with the travel resistance R of the accelerator pedal, base on the function or curve of Ls-R which should be obtained by experiment to provide the set value of the variable of supplying fuel flow Ls for the said PID loop 2; the process variable PV is the actually supplying fuel flow gained by measuring;
In the process of regulating under the automatic or the manual mode the PID loop 2 is used to correct the difference between the pedal supplying fuel flow and the output fuel flow of the PID loop 1 at the shifting moment while the PID loop 1 control is being switched to the accelerator pedal control, thus overcome artificial bumpy feeling, that is to say, after shifting gear not switch the supplying fuel to that of pedal operating but to that of PID loop 2 controlling and equal the actual supplying fuel flow to the corresponding fuel flow of the pedal controlling as soon as possible, when the supplying fuel flows difference between the pedal controlling with the actual supplying up to its set limit the program will deliver the control of throttle to the pedal;
The smoothing fuel PID loop 3: this control loop is used for overcoming the fuel dithering due to bumpy road or factitiousness;
The set value in the said PID loop is the supplying fuel flow Ls corresponding with the accelerator pedal travel resistance R, the process variable PV is the actual supplying fuel flow Lp. When check out the strongly dithering of the supplying fuel flow by the subprogram named acceleratefuel( ) this PID loop starts to regulate the fuel supplying till the error is less than the set value or the fuel dithering disappeared then quits; its output is used to regulate the throttle valve, which priority is higher than that of accelerator pedal but lower than that of the PID loop 1 as well as the PID loop 2, the output of brake to idle motor owns the highest priority;
Or can connect a smoothing fuel bottle to the supplying fuel tube after supplying fuel pump before the throttle valve instead of the function of the said PID loop 3.

6. According to claim 1 said an integrated automatic manual stepless gearbox device, wherein its characters lies in, this device is enabled to be maintained namely which partial parameters can be set manually via the subprogram HMI. with installing a touch screen in the driver cab, then input password to set the following parameters at any time: Password modification, the selection of startup with meshing fully or un-fully, the low speed value setup for detaching the clutch by force, enabling the function of creeping at low speed, the selection of gears before startup, enabling to force the gear to 4 or 5 gear position after startup, setting the value of time locked in 4 or 5 gear position after startup, setting the shifting gear speed as well as its delay time to confirm the said speed, enabling the function of synchronizing velocity PID, enabling the function of meshing and tracking PID, enabling the function of smoothing fuel PID, enabling the function of automatically shifting over gear, enabling the function of automatically shifting far gear, enabling the function of automatically shifting over down gear, enabling the function of automatically shifting far down gear, setting the acceleration value of speed or supplying fuel for shifting over, far, over down or far down gears, setting the locking gear time after shifting over, far, over down, far down gears, setting the period of delay to shift neutral gear after stopping, enabling the function of starting with clutch switches manually, recovering the manufacturer setup; the set functions can be enabled after achievement of setting and can run at once, the SCM will load and enable the last strategy setup after reboot.

7. According to claim 1 said an integrated automatic manual stepless gearbox device, wherein its characters lies in, In order to carry out the said above functions designed the microcomputer program, therein the automatic control program named auto program which comprises various functions of this device as follow: the selection of shifting gear before startup named startup class selecting, shifting 4 or 5 gear after startup with 2 or 3 gear named the switching to 4 class after starts with 2 or 3 class, automatically shifting over, far, over down or far down gears named auto switches for exceeding class, automatically shifting gear according to the vehicle speed named auto switches class by class; therein the manual control program named semiauto program which comprises various functions as follow: presetting the shift ratio named presetting the ratio of semiauto shift gears; therein several sub-programs which comprises various functions of the device as follow: master control named master controller ( ) comprises functions of the fundamental control to the clutch, brake discs and throttle, of the control to startup mode, of the advance regulation for stepless shifting for gearbox, automatically shifting neutral gear after stop for few minutes named stopped to 0 class( ), shifting gear named ZDHDn( ), frequency measuring named frequency( ), acceleration measuring named accelerate( ), supplying fuel acceleration and supplying fuel dithering measuring named acceleratefuel ( ), setting various parameters named HMI( ).

8. According to claim 1 said an integrated automatic manual stepless gearbox device, wherein its characters lies in, In the condition of the said brake pedal replaced with the clutch-brake pedal, it is invalid for the second-half travel of the clutch lever and the first-half travel of the brake lever, wherein, The sliding wire-wound rheostat with half-valid travel is the main parts of the electronic type clutch lever, its second-half is short-circuit slice, two electromagnets (31) are located above the sliding slices so that the electromagnets can detach the sliding slices with the wirewound rheostat to reduce their abrasion when the vehicle speed exceeds its set value, in case the clutch pedal and the brake pedal are laid on the left, the said sliding wire-wound rheostat is valid in the whole travel;
the value of said sliding wire-wound rheostat is transformed into standard engineering signal via the microcomputer program to control the clutch motor driving the clutch, the manual clutch switches control the microcomputer program to output the movement control signal which based on the matched movement curve to control the clutch motor, and the clutch action periods are set according to the principle of pedaling fast and releasing slow, isolating the control of said sliding wire-wound rheostat when the vehicle speed exceeding set value, the manual clutch switches owns priority over the clutch pedal at any time;
Install a travel switch at the start point of brake travel, when the velocity of vehicle exceeding the set value and emerging said travel switch signal, the SCM outputs signal to control the idle electromagnetic valve (51) to idle the motor.

9. According to claim 1 said an integrated automatic manual stepless gearbox device, wherein its characters lies in, In the case of using the high and low speeds of the servo motor with controller or double speeds motor to control the said device, with suitable speed to control clutch meshing and high speed of motor to control clutch detaching, the realization of the control for the said device can be designed with intermediate relays and logic chips but not microcomputer.

10. According to claim 1 said an integrated automatic manual stepless gearbox device, wherein its characters lies in, In the case of the brake lever of said clutch-brake pedal (1), its front reset spring (12) force the nail-type pole (13) back to the bottom of the cylinder (15) when the said pedal is released, but the said cylinder is stopped by the circle (16) which is fixed on the body of the vehicle; when the pedal acting the nail head (14) is stopped by the end circle (17) of the said cylinder and then draws the cylinder along with the brake discs moving, so that can make free on its first-half braking travel of the brake lever.

11. According to claim 1 said an integrated automatic manual stepless gearbox device, wherein its characters lies in, In the case of the half-travel clutch lever of said clutch-brake pedal (2), wherein its shell opened a slot (25) on its inner wall and fixed on the body of vehicle is square tube or circle tube, a fork pole which handle links to the pedal and supported by a reset spring (21) locates in upside of the inner shell, a pin (23) together with its reset spring and guide-pole are assembled on the top of a branch of said fork pole, when the fork pole moves downwards the said pin will force the arrow pole (26) head to be extruded out the said slot and be hung on the barb which is the top of another branch of the said fork pole, on an proper position of the inner wall opposite the said slot install a detaching pin (24) along with its reset spring and guide-pole which will compel the said arrow pole head into the said slot when the said fork pole moves upwards; a pull spring (22) links the underside of the arrow pole to the arm of the clutch, the pull of the said pull spring along with the thrust of the said detaching pin fix the arrow pole head into the said slot;
The said above scheme which force the arrow pole detaching and hanging on the slot can be replaced with the following structure: the barb (28) which another end supports on the branch of the fork pole with its compressed spring and guide-pole joints to the branch top of the said fork pole with a shaft, on an proper position of the inner wall opposite the said slot install a spring film (27) supported by a compressed spring, when the said arrow pole move up to a proper position the arrow pole head will be detached with the said barb and be compelled into the said slot;
The said above pull spring (22) should be hung on the shell (29), additionally link the underside of the said arrow pole to the clutch arm (4) with a rigid pole to avoid enlarging the error of mechanical zero point of the clutch arm;
The said above half-travel clutch lever will occur a back-travel error when shifting between the first-half valid travel and the second-half invalid travel, it can be reduced but can not be zero via precisely manufacture, so that should design the position of the back-travel error occurring outside the said valid travel to avoid the error occurring at the period of controlling the clutch;
When the said half-travel clutch lever of the clutch-brake pedal cooperate with the said manual clutch switches, the manual clutch switches control the clutch via a servo motor or a double speed motor but the half-travel clutch lever operate the clutch directly, and all them link to the clutch arm (4) through brake cables, herein their operating to the clutch are OR logic but the manual clutch switches own the priority of control which will realize the control for shifting gear while the clutch-brake pedal operates the clutch un-fully meshing, the operation of the manual clutch switches for shifting gear is easier than that of pedal.
